(19) United States
(12) Patent Application Publication
(10) Pub. No.: US 2007/0192489 A1
(43) Pub. Date: Aug. 16, 2007

(54) METHOD AND APPARATUS TO FACILITATE AUTOMATIC SELECTION OF SOTWARE PROGRAMS TO BE DISTRIBUTED TO NETWORK ELEMENTS

(75) Inventors: Loren J. Rittle, Naperville, IL (US); Chen Jia, Vernon Hills, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,113

(22) Filed: Feb. 14, 2006

(51) Int. Cl. G06F 15/173

(52) U.S. Cl. 709/226

(57) ABSTRACT

A plurality of executable software programs are received (101). By one approach these executable software programs are intended for distribution to one or more available candidate distributed network elements. Example network elements include, but are not limited to, wireless sensor elements. These executable software programs are then automatically assessed (102) with respect to at least one predetermined constraint to provide corresponding assessment information. One or more of the executable software programs are then automatically selected (103) to be permitted to be distributed to the network elements as a function, at least in part, of the aforementioned assessment information.

### TECHNICAL FIELD

This invention relates generally to software program distribution.

### BACKGROUND

Programmable software-based platforms of various kinds are known in the art. In some cases, though programmable, such platforms may comprise dedicated-purpose platforms and hence remain essentially unaltered over the course of a usable operational life. In many other cases, however, such platforms are updated from time to time as an expected and normal operational event. An example of the latter comprises Mate virtual machine platforms that support a relatively small executable environment having, for example, four loading points to receive corresponding discrete software programs on a relatively dynamic basis. Such platforms have use, for example, in conjunction with ad hoc wireless sensing nodes.

In many cases such updating occurs via direct user intervention. That is, a user (such as a system administrator) personally effects, supervises, or otherwise manages the installation of new software for a given programmable platform. For many operating scenarios, this approach works relatively well. In other settings, however, such an approach can give rise to various problems.

For example, distributed programmable network elements are known in the art with wireless sensor networks representing one salient example. A plurality of wireless sensors may be distributed throughout a building, for example, to monitor various environmental circumstances of interest (such as temperature, humidity, proximal human activity, noise, motion, and essentially any other sensable condition that might occur proximal to such a sensor).

In some cases such a network of distributed network elements may comprise a set of time-shared resources. In such a case, one person may be permitted access to utilize (wholly or partially) the network (or elements of the network) during one period of time while another person may have such authorization at a different time. Frequent re-programming of the corresponding network elements will typically occur when supporting such an operational scenario.

Many such network elements, however, comprise relatively resource-poor operational platforms. Significant limitations may exist, for example, with respect to available memory, computational capacity, computational scheduling, power resources, power consumption (including power consumption scheduling), multi-tasking capabilities, peripherals management, and so forth. As a result, unsupervised re-programming of such network elements by otherwise authorized individuals and organizations can lead to significant problems up to and including mission failure for one or more of the authorized parties. Supervising requested re-programming in order to avoid such problems, however, presents its own set of corresponding issues and problems. Concerns include, but are not limited to, headcount overhead, training, timely reviews, and ensuring well-informed and well-founded decisions, to note but a few.

### BRIEF DESCRIPTION OF THE DRAWINGS

The above needs are at least partially met through provision of the method and apparatus to facilitate automatic selection of software programs to be distributed to network elements described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these embodiments, a plurality of executable software programs are received. By one approach these executable software programs are intended for distribution to one or more available candidate distributed network elements. Example network elements include, but are not limited to, wireless sensor elements. These executable software programs are then automatically assessed with respect to at least one predetermined constraint to provide corresponding assessment information. One or more of the executable software programs are then automatically selected to be permitted to be distributed to the network elements as a function, at least in part, of the aforementioned assessment information.

By one approach, such automatically selected executable software programs are then subsequently distributed to the corresponding network elements to facilitate, for example, installation of such executable software programs. If desired, upon determining that a particular executable software program is not to be presently selected for such distribution, a corresponding indication can be provided to a source as corresponds to that denied executable software program.

The predetermined constraint(s) can vary with the specific needs and requirements of a given application setting. Typical examples, however, likely include (but are not limited to) network element memory capacity, power consumption, computational capacity, an aggregate number of executable software programs as may be locally supported, operational requirements for specific executable software programs, and/or operational conflicts as may occur as between two or more of the executable software programs.

So configured, these teachings readily support an automated process to assess a pool of candidate executable software programs and to select specific executable software programs to be distributed to one or more distributed network elements. More particularly, these teachings are readily applied and leveraged in a manner that aids in avoiding any of a wide variety of operational conflicts and problems. This, in turn, will aid in ensuring the viable and effective operation of the distributed network elements themselves. Those skilled in the art will understand and appreciate that such benefits are largely attained with little overhead live supervision being necessary.

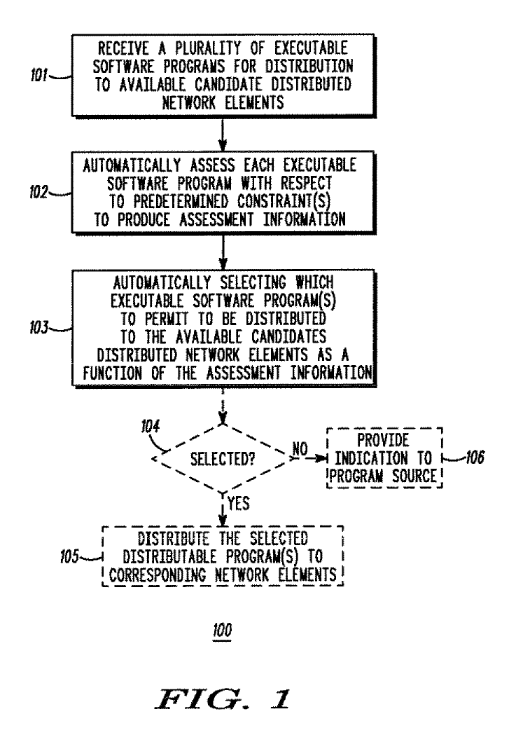

These and other benefits may become clearer upon making a thorough review and study of the following detailed description. Referring now to the drawings, and in particular to FIG. 1, these teachings provide for a process 100 that receives 101 a plurality of executable software programs intended for distribution to at least one of a plurality of available candidate distributed network elements. By one approach these distributed network elements may comprise, at least in part, programmable environmental sensors as are presently known or as may be developed in the future.

These executable software programs may be received from a same software program source or, perhaps more typically, may be received from any of a plurality of software program sources. The latter will perhaps exemplify a suitable operating scenario when the executable software programs comprise various wireless sensor platform operating instructions as may be provided by any of a variety of authorized users. By one approach, such executable software programs may be received at a gateway for the plurality of available candidate distributed network elements.

These executable software programs may, or may not, be essentially identical to one another and/or compatible with one another. More typically, such executable software programs are likely to in fact differ considerably from one another with respect to any number of characterizing and/or operational attributes. These teachings are not particularly sensitive to the provision of any particular kind or type of executable software programs. As such programs are generally otherwise known in the art, and as other programs are likely to be developed in the future, for the sake of brevity additional description regarding such executable software programs will not be provided here.

This process 100 then provides for automatically assessing 102 each of the plurality of executable software programs with respect to at least one predetermined constraint to provide corresponding assessment information. The particular predetermined constraint (or constraints) employed for this purpose will of course vary with respect to the particular needs and/or requirements of a given application setting. A non-exhaustive illustrative listing would comprise constraints as relate to one or more of:

memory capacity of at least one of the plurality of available candidate distributed network elements;

power consumption of at least one of the plurality of available candidate distributed network elements;

computational capacity of at least one of the plurality of available candidate distributed network elements;

a number of discrete executable software programs as may be supported by at least one of the plurality of available candidate distributed network elements;

operational requirements of at least one of the executable software programs;

operational conflicts as between at least two of the plurality of executable software programs; and/or

results of a first-order predicate calculus calculation over attributes reported from the plurality of available candidate distributed network elements.

The particular constraint (or constraints) to employ in a given setting may be relatively predetermined and statically set. Or, if desired, such constraint(s) may be selected on a more dynamic fashion (and based, for example, upon a day of the week or time of day, a priority level associated with a source of the program to be assessed, and so forth). Depending upon the needs of a given application it is also possible that this constraint is automatically selected or, if desired, identified or otherwise received from an end user. Such an end user may comprise, for example, an entity having operational and/or management authority to make such a selection.

Having assessed such executable software programs, this process 100 then provides for automatically selecting 103 which of the plurality of executable software programs to permit to be distributed to the at least one of the plurality of available candidate distributed network elements. By one approach, this selection occurs as a function, at least in part, of the assessment information described above. There are various times and ways by when such selection can occur. By one approach this selection step can comprise automatically assessing each of the plurality of executable software programs separately from others of the plurality of executable software programs. By another approach, this step can comprise storing the executable software programs upon receiving each executable software program and then automatically assessing a group of the plurality of executable software programs.

The latter approach may be useful, for example, to assess potential operational requirements conflicts as may exist between two different executable software programs. To illustrate, one executable software program may require an enabling sensor platform to awaken from a sleep mode of operation every five seconds while another executable software program may require an enabling sensor platform to awaken from a sleep mode of operation every three seconds. While either executable software program may be adequately supported by a given wireless sensor platform, it may be possible that placing both such programs in a shared platform will consume a debilitating quantity of available power resources and hence should be avoided. Assessing such executable software programs as a group may aid in identifying such conflicts.

In general, it will be appreciated that these teachings serve to identify conflicts presented by one or more executable software programs with respect to one or more operational constraints of interest prior to distributing such programs to a corresponding set of enabling platforms. Executable software programs that are, in fact, selected 104 may then be distributed 105 to corresponding available candidate distributed network elements. Such distribution can occur immediately upon making this selection 104 or can occur at such other time as may be convenient or appropriate.

If desired, an indication can be provided 106 to the source of an executable software program that is not selected 104 for such distribution. This substance of this indication can vary with the needs or requirements of a given application setting. By one approach this indication can comprise a simple indication that distribution of the executable software program has been denied. By another approach this indication can provide, for example, information regarding the specific basis for denying distribution of the executable software program. This can comprise, for example, information regarding the particular constraint or constraints that contributed to the decision to not select the executable software program for distribution.

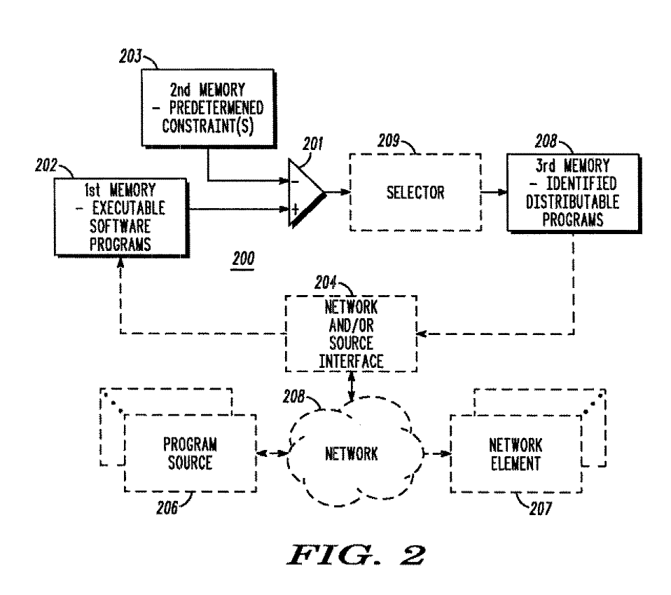

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

If desired, the depicted apparatus 200 may comprise, for example, a gateway for a corresponding plurality of available candidate distributed network elements 207. As noted earlier, these network elements 207 may comprise, for example, programmable environmental sensors such as those that are presently known or those that are developed going forward.

In this illustrative example, this apparatus 200 comprises a first and second memory 202 and 203 that operably couple to the inputs of a comparator 201. The first memory 202 serves, in this embodiment, to store a plurality of executable software programs. These executable software programs are intended for distribution to one or more of the aforementioned network elements 207. By one approach at least some of these executable software programs are provided by one or more corresponding program sources 206 using whatever submission protocol may be selected for use in a given instance. By one approach this apparatus 200 can optionally further comprise a network and/or source interface 204 to facilitate reception of such executable software programs from these program sources 206. Depending upon the specifics of a given application setting, the program sources 206 may communicate directly with this network and/or source interface 204 or may communicate via one or more intervening networks 205.

Numerous examples of both wireless and non-wireless communication networks exist in the art and others will no doubt be fashioned going forward. As these teachings are not dependent upon the selection of any particular network topology, architecture, protocol, or implementation details, for the sake of brevity additional details regarding such a network are not provided here.

The second memory 203, in this embodiment, serves to store one or more predetermined constraints. This predetermined constraint(s) comprises, by one approach, at least a partial basis by which one or more of the executable software programs are to be assessed as per these teachings. The particular predetermined constraint(s) selected for use in a given setting will of course vary with the needs, requirements, and capabilities as tend to characterize that given setting. For purposes of this illustrative embodiment, this predetermined constraint(s) may comprise, for example, one or more of the previously described constraints presented above.

In this illustrative embodiment the comparator 201 serves, at least in part, to automatically assess at least one (and preferably each) of the plurality of executable software programs with respect to the predetermined constraint(s) to provide corresponding assessment information. This assessment information may comprise, for example, general or specific information regarding instances where a given executable software program fails to comply with a specific corresponding predetermined constraint. This assessment information may further comprise, if desired, information regarding a relative extent or an amount by which a given executable software program fails to comply with such a predetermined constraint.

In this illustrative embodiment the apparatus 200 further comprises a third memory 208. This third memory 208 serves to store identified distributable programs as correspond to those programs that are to be permitted to be distributed to the network elements 207. These identified distributable programs have been so selected, at least in part, as a function of the aforementioned assessment information. By one approach these identified distributable programs can comprise the actual corresponding executable software itself. By another approach these identified distributable programs can comprise an identifier for such selected executable software programs.

By one approach the comparator 201 and third memory 208 are sufficiently capable to effect the assessment and selection process described. If desired, however, this apparatus 200 may further optionally comprise a selector 209 that operably couples to the comparator 201 and the third memory 208. Such a selector may serve, for example, to receive the comparator's assessment information and to effect automatic selection of the particular executable software programs that are to be permitted to be distributed to the network element(s) 207.

So configured, the comparator 201 and/or such a selector 209 can comprise a computer storage medium having executable software programming stored therein to effect or otherwise facilitate the aforementioned steps and processes.

Those skilled in the art will recognize and understand that such an apparatus 200 may be comprised of a plurality of physically distinct elements as is suggested by the illustration shown in FIG. 2 It is also possible, however, to view this illustration as comprising a logical view, in which case one or more of these elements (such as the various memories depicted) can be enabled and realized via a shared platform. It will also be understood that such a shared platform may comprise a wholly or at least partially programmable platform as are known in the art.

So configured, these teachings are readily deployed in a wide variety of application settings. These teachings can be deployed, if desired, relatively transparently with respect to both the executable software program sources and the network elements. Accordingly, these teachings are readily used with legacy installations and platforms. Those skilled in the art will appreciate that these teachings facilitate an automated approach to ensuring that various executable software programs as may be submitted by a potentially wide variety of sources are appropriately vetted with respect to one or more operational constraints of choice. This, in turn, can aid in ensuring that the corresponding network of network elements operate in a satisfactory and effective manner.

Accordingly, these teachings permit the breadth and depth of a program source user base to expand to include, if desired, program sources that may be less skilled and knowledgeable with respect to the specific limitations as may characterize a given network element and/or deployment of such network elements. By providing for automatic assessment and vetting of such executable software programs one may, if one wishes, effectively ignore the skill and knowledge base of the program source; a given program can be accepted, or denied, based upon a constraint-based analysis of the program itself without concern for the specifics of the program source itself.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example, different program sources may have different corresponding priorities associated therewith. These priorities may be taken into account when effecting these teachings. As one simple example, these teachings may be used to detect that two candidate executable software programs conflict with one another in a manner that will preclude deploying both together at a single network element. When one of these candidates has been provided by a program source having a relatively higher priority, then that higher priority can be used to form a basis for selecting the particular candidate to select for distribution and which to select for denial.

We claim:

1. A method comprising:
receiving a plurality of executable software programs intended for distribution to at least one of a plurality of available candidate distributed network elements;
automatically assessing each of the plurality of executable software programs with respect to at least one predetermined constraint to provide corresponding assessment information;
automatically selecting which of the plurality of executable software programs to permit to be distributed to the at least one of the plurality of available candidate distributed network elements as a function, at least in part, of the assessment information to thereby provide identified distributable programs.

2. The method of claim 1 wherein receiving a plurality of executable software programs comprises receiving the plurality of executable software programs from at least one of:
any of a plurality of software program sources;
a same software program source.

3. The method of claim 1 wherein receiving a plurality of executable software programs comprises receiving the plurality of executable software programs at a gateway for the plurality of available candidate distributed network elements.

4. The method of claim 1 the plurality of available candidate distributed network elements each comprise, at least in part, programmable environmental sensors.

5. The method of claim 1 wherein the at least one predetermined constraint comprises at least one of a constraint with respect to:
memory capacity of at least one of the plurality of available candidate distributed network elements;
power consumption of at least one of the plurality of available candidate distributed network elements;
computational capacity of at least one of the plurality of available candidate distributed network elements;
a number of discrete executable software programs as may be supported by at least one of the plurality of available candidate distributed network elements;
operational requirements of at least one of the executable software programs;
operational conflicts as between at least two of the plurality of executable software programs.

6. The method of claim 1 wherein automatically assessing each of the plurality of executable software programs with respect to at least one predetermined constraint to provided corresponding assessment information comprises automatically assessing each of the plurality of executable software programs separately from others of the plurality of executable software programs.

7. The method of claim 1 wherein automatically assessing each of the plurality of executable software programs with respect to at least one predetermined constraint to provided corresponding assessment information comprises:
storing the executable software programs upon receiving each executable software program;
automatically assessing a group of the plurality of executable software programs.

8. The method of claim 1 further comprising:
distributing the identified distributable programs to corresponding available candidate distributed network elements.

9. The method of claim 1 further comprising:
providing an indication to a source of an executable software program that is not one of the identified distributable programs regarding present non-distribution of the executable software program.

10. An apparatus comprising:
a first memory having stored therein a plurality of executable software programs intended for distribution to at least one of a plurality of available candidate distributed network elements;
a second memory having stored therein at least one predetermined constraint;
a third memory having stored therein identified distributable programs as correspond to those of the plurality of executable software programs that are to be permitted to be distributed to the at least one of the plurality of available candidate distributed network elements as a function, at least in part, of the assessment information;
a comparator having inputs operably coupled to the first memory and the second memory and having an output that is operably coupled to the third memory.

11. The apparatus of claim 10 wherein the comparator comprises assessment means for automatically assessing each of the plurality of executable software programs with respect to the at least one predetermined constraint to provide corresponding assessment information.

12. The apparatus of claim 10 further comprising:
a selector having an input operably coupled to receive assessment information at the output of the comparator and having an identified software programs output that is operably coupled to the third memory.

13. The apparatus of claim 12 wherein the selector comprises means for automatically selecting which of the plurality of executable software programs to permit to be distributed to the at least one of the plurality of available candidate distributed network elements as a function, at least in part, of the assessment information to thereby provide identified distributable programs.

14. The apparatus of claim 10 wherein the at least one predetermined constraint comprises at least one of a constraint with respect to:
memory capacity of at least one of the plurality of available candidate distributed network elements;
power consumption of at least one of the plurality of available candidate distributed network elements;
computational capacity of at least one of the plurality of available candidate distributed network elements;
a number of discrete executable software programs as may be supported by at least one of the plurality of available candidate distributed network elements;
operational requirements of at least one of the executable software programs;
operational conflicts as between at least two of the plurality of executable software programs;
results of a first-order predicate calculus calculation over attributes reported from the plurality of available candidate distributed network elements to the apparatus.

15. The apparatus of claim 10 further comprising
a network interface operably coupled to the first memory and the third memory and being configured and arranged to distribute the identified distributable programs to corresponding available candidate distributed network elements.

16. The apparatus of claim 10 further comprising:
a source interface operably coupled to the third memory and being configured and arranged to provide an indication to a source of an executable software program that is not one of the identified distributable programs regarding present non-distribution of the executable software program.

17. A computer storage medium having executable software programming stored therein, the executable software programming comprising steps for facilitating:
receiving a plurality of executable software programs intended for distribution to at least one of a plurality of available candidate distributed network elements;
automatically assessing each of the plurality of executable software programs with respect to at least one predetermined constraint to provide corresponding assessment information;
automatically selecting which of the plurality of executable software programs to permit to be distributed to the at least one of the plurality of available candidate distributed network elements as a function, at least in part, of the assessment information to thereby provide identified distributable programs.

18. The computer storage medium of claim 17 wherein the executable software programming stored therein further comprises steps for facilitating:
receiving the at least one predetermined constraint from an end user.

19. The computer storage medium of claim 17 wherein the executable software programming stored therein further comprises steps for facilitating:
distributing the identified distributable programs to the at least one of the plurality of available candidate distributed network elements.

20. The computer storage medium of claim 17 wherein the executable software programming stored therein further comprises steps for facilitating:
providing an indication to a source of an executable software program that is not one of the identified distributable programs regarding present non-distribution of the executable software program.
